(19) United States
(12) Patent Application Publication
(10) Pub. No.: US 2002/0002666 A1
(43) Pub. Date: Jan. 3, 2002

(54) CONDITIONAL OPERAND SELECTION USING MASK OPERATIONS

(76) Inventors: CAROLE DULONG, SARATOGA, CA (US); ROGER A. GOLLIVER, BEAVERTON, OR (US)

Correspondence Address: BLAKELY SOKOLOFF TAYLOR & ZAFMAN, 12400 WILSHIRE BOULEVARD SEVENTH, FLOOR, LOS ANGELES, CA, 90025

(21) Appl. No.: 09/170,472

(22) Filed: Oct. 12, 1998

(51) Int. Cl. G06F 9/00

(52) U.S. Cl. 712/224

(57) ABSTRACT

The present invention is a method and apparatus for transferring data from at least two source operands to a destination operand based on a condition. The two source operands are stored in respective source registers. A condition register stores a condition operand from the condition. A masking circuit is coupled to the two source registers for masking the two source operands by the condition operand to generate a masking result. A selector is coupled to the masking circuit for selecting elements of the two source operands based of the masking result.

### BACKGROUND

1. Field of the Invention

This invention relates to computer systems. In particular, the invention relates to microprocessor instruction design.

2. Description of Related Art

As microprocessors become more and more advanced, the design of instructions to take full advantage of the micro-architecture becomes more challenging. From the user's point of view, it is preferable to have instructions that facilitate the programming task with powerful features and fast execution time. From the microprocessor architect's point of view, it is preferable to have instructions that are sufficiently powerful and simple to implement, without using much hardware resource. These preferences tend to be conflicting in many instances.

One type of operation that is useful for programming tasks is the selection of operands based on a certain condition. This conditional selection of operands allows the implementation of complex decision logic operations, such as the “case” or the “if . . . then . . . else” construct in several high level languages. This type of instruction is also useful to implement a conditional move of operands.

When the architecture involves vector operands like in the single instruction multiple data (SIMD) machine, the conditional selection or data move becomes complex. One way is to use a vector of flags that correspond to the condition and to perform the move according to the individual flags. However, this technique is inefficient because it involves complex hardware and takes much processing time.

Therefore there is a need in the technology to provide a simple and efficient method to conditionally select the vector operands.

### SUMMARY

The present invention is a method and apparatus for transferring data from at least two source operands to a destination operand based on a condition. The two source operands are stored in respective source registers. A condition register stores a condition operand from the condition. A masking circuit is coupled to the two source registers for masking the two source operands by the condition operand to generate a masking result. A selector is coupled to the masking circuit for selecting elements of the two source operands based of the masking result.

### BRIEF DESCRIPTION OF THE DRAWINGS

The features and advantages of the present invention will become apparent from the following detailed description of the present invention in which:

FIG. 1 is a diagram illustrating a computer system in which one embodiment of the invention can be practiced.

FIG. 2 is a diagram illustrating a select circuit for the select instruction according to one embodiment of the invention.

FIG. 3 is a flowchart illustrating a process of selecting operands according to one embodiment of the invention.

### DESCRIPTION

The present invention is a method and apparatus for selecting operands as a conditional move in a processor. The technique provides a move of a vector without using another vector or a vector flags. The instruction format includes a three-operand having four addresses. A condition register is used as a mask register to mask the source registers. The selection of operand is performed based on the result of the masking operation. The technique provides a convenient and efficient method to conditionally move a vector operand.

In the following description, for purposes of explanation, numerous details are set forth in order to provide a thorough understanding of the present invention. However, it will be apparent to one skilled in the art that these specific details are not required in order to practice the present invention. In other instances, well known electrical structures and circuits are shown in block diagram form in order not to obscure the present invention.

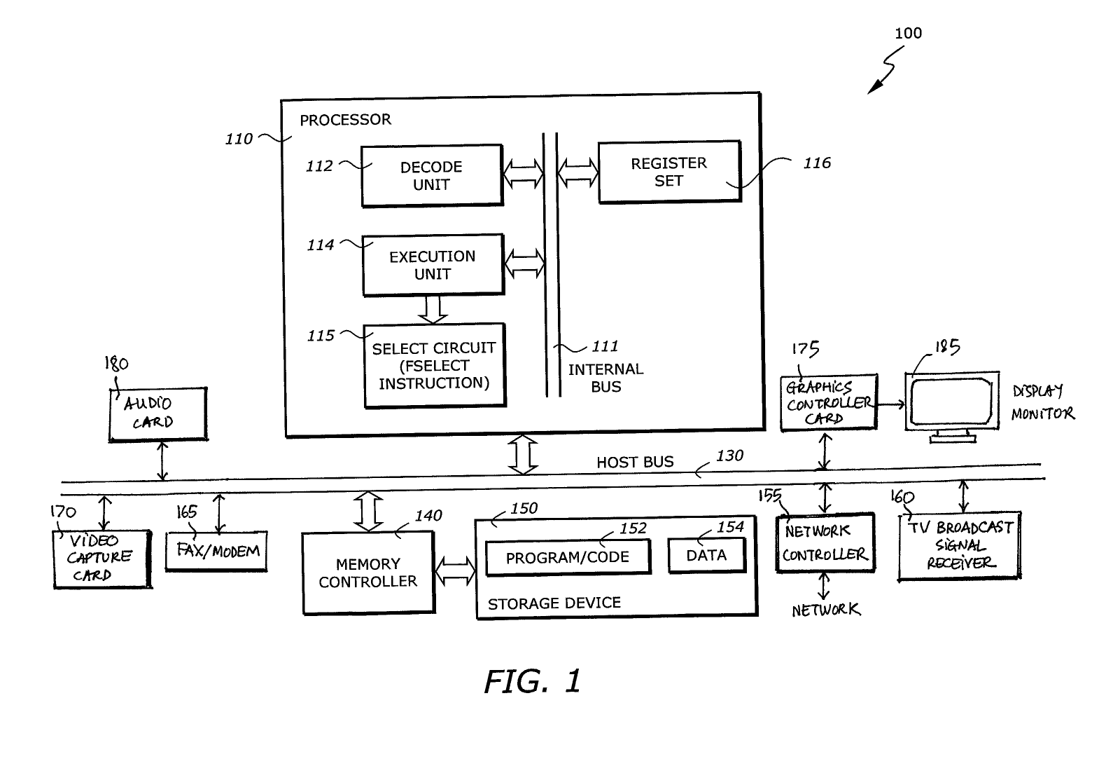

FIG. 1 is a diagram illustrating one embodiment of a computer system 100 in which one embodiment of the invention may be utilized. The computer system 100 comprises a processor 110, a host bus 130, a memory controller 140, and a storage device 150.

The processor 110 represents a central processing unit of any type of architecture, such as complex instruction set computers (CISC), reduced instruction set computers (RISC), very long instruction word (VLIW), or hybrid architecture. While this embodiment is described in relation to a single processor computer system, the invention could be implemented in a multi-processor computer system.

The memory controller 140 provides various access functions to the storage device 150. The memory controller 140 is coupled to the host bus 130 to allow the processor to access the storage device 150. The storage device 150 represents one or more mechanisms for storing information. For example, the storage device 150 may include non-volatile or volatile memories. Examples of these memories include flash memory, read only memory (ROM), or random access memory (RAM).

FIG. 1 also illustrates that the storage device 150 has stored therein program code 152 and data 154. The program code 152 represents the necessary code for performing any and/or all of the techniques in the present invention. The data 154 stores data used by the program code 152, graphics data and temporary data. Of course, the storage device 165 preferably contains additional software (not shown), which is not necessary to understanding the invention.

FIG. 1 additionally illustrates that the processor 110 includes an internal bus 111, a decode unit 112, an execution unit 114, a register set 116, and a select circuit 115. Of course, the processor 110 contains additional circuitry, which is not necessary to understanding the invention. The decode unit 112 is used for decoding instructions received by processor 110 into control signals and/or microcode entry points. In response to these control signals and/or microcode entry points, the execution unit 114 performs the appropriate operations.

The register set 116 represents a storage area on processor 110 for storing information, including control/status information, numeric data. In one embodiment, the register set 116 includes a number of floating-point registers holding vector operands. The select circuit 115 is used to select the operands when the select instruction is executed.

In addition to other devices, one or more of a network controller 155, a TV broadcast signal receiver 160, a fax/modem 165, a video capture card 170, a graphics controller card 175, and an audio card 180 may optionally be coupled to bus 130. The network controller 155 represents one or more network connections (e.g., an ethernet connection). While the TV broadcast signal receiver 160 represents a device for receiving TV broadcast signals, the fax/modem 165 represents a fax and/or modem for receiving and/or transmitting analog signals representing data. The image capture card 170 represents one or more devices for digitizing images (i.e., a scanner, camera, etc.). The audio card 180 represents one or more devices for inputting and/or outputting sound (e.g., microphones, speakers, magnetic storage devices, optical storage devices, etc.). The graphics controller card 175 represents one or more devices for generating images to be displayed on a display monitor 185.

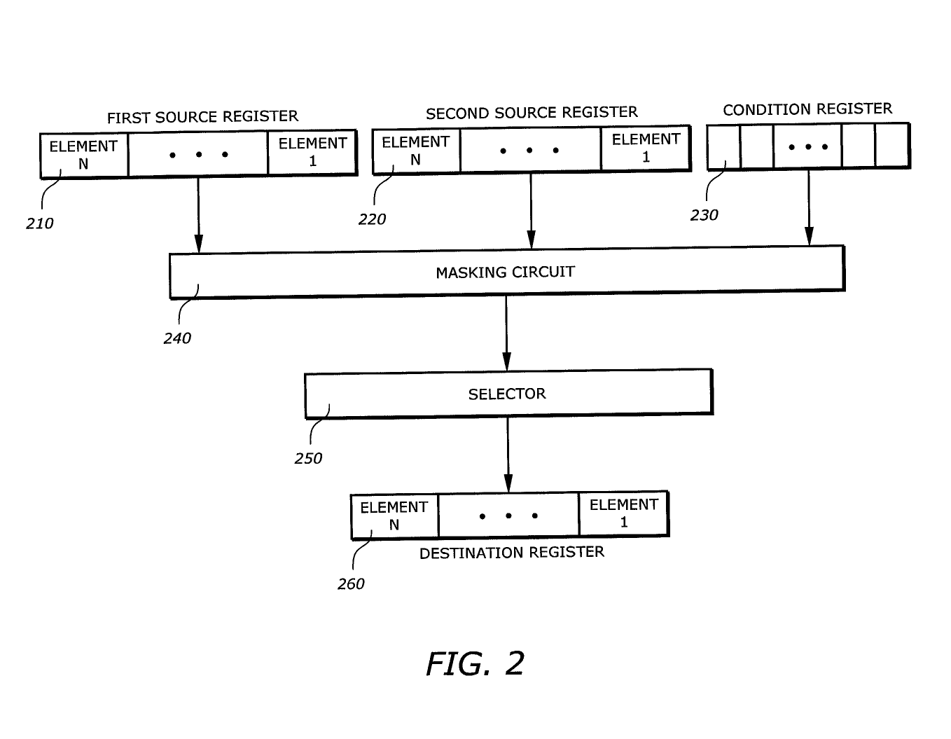

FIG. 2 is a diagram illustrating a select circuit for the select instruction according to one embodiment of the invention. The select circuit 115 includes a first source register 210, a second source register 220, a condition register 230, a mask circuit 240, a selector 250, and a destination register 260.

The first and second source registers 210 and 220 and the destination register 260 may have the same or different data representation formats. The first and second source registers 210 and 220 store the two source operands, one of which is transferred to the destination register 260. In one embodiment, the first and second source registers 210 and 220 belong to the register set 116 (FIG. 1). In an SIMD processor, each of these registers store N data elements, N is a positive integer. The data elements may be in any representation format such as integer, single precision floating-point (FP), double-precision FP, or extended double-precision FP.

The condition register 230 stores the condition operand to be evaluated for the selection of the source registers 210 and 220. The condition can be any arithmetic or logical condition. Examples of these conditions include equal to zero, greater than zero, less than zero, etc. The condition register 230 may be in any data representation format that facilitates the evaluation of the condition. The condition operand acts as a masking element. The values of the condition depend on the results of the evaluated conditions. The condition register stores a number of bits or a number of bit fields which correspond to the number of elements in the source operands. For example, if the source operands have N elements, the condition register has N bit fields or N bits, where each bit field (in the N-bit field organization) or each bit (in the N-bit organization) corresponds to each element of the source operands. In one embodiment, the bit field of the condition register 230 is either all 1's or all 0's.

The masking circuit 240 performs a number of masking operations. The masking circuit 240 includes logic elements such as AND gates and/or OR gates together with temporary registers to store temporary results. In one embodiment, the masking operation is performed on an element-by-element basis. For N elements, there are N masking operations. In an SIMD architecture, these N masking operations take place simultaneously. The masking circuit perform the following operations:

T1=X1 AND Z

T2=X2 AND (NOT Z)

where X1 and X2 represent the contents of the first source register 210 and the second source register 220, respectively. Z represents the contents of the condition register 230. T1 and T2 represent two temporary registers. When each bit field of Z is either all 0's or all 1's, the above masking operations result in a temporary result in each bit field of all 0's and the corresponding elements of X1 and X2.

When a bit field of Z is all 0's, the corresponding elements of T1=0 and T2=X2. In this bit field, the first masking result is 0 and the second masking result is X2.

When a bit field of Z is all 1's, the corresponding elements of T1=X1 and T2=0. In this bit field, the first masking result is X1 and the second masking result is 0.

The selector 250 selects one of the first and second source operands in the first and second source registers 210 and 220 based on the result of the evaluation of the condition operand. The selector 250 may be implemented by multiple two-to-one multiplexers which select at each bit field location one of the source registers 210 and 220 based on the result of the masking operations in the masking circuit. When a bit field of the condition register 230 is either all 0's or all 1's, the selection logic can be performed by ORing or ANDing all the bits in that bit field of the condition register. The result of this ANDing or ORing is used as the select signal to the multiplexer. For N elements, there will be N two-to-one multiplexers and N selection signals. In another embodiment, the selector 250 may be implemented by multiple OR gates which perform an ORing operation on the temporary registers T1 and T2. As illustrated above, when a bit field of the condition register 230 is either all 0's or all 1's, the results of the masking operations at that bit field include zero's and one of X1 and X2. By performing an OR operation on T1 and T2, an element in one of the source operands X1 and X2 is generated. For N OR operations, N elements in any combination of the source operands X1 and X2 are generated.

The destination register 260 stores the destination operand selected from the first and second source registers 210 and 220. In one embodiment, the destination register 260 is a register separate from the first and second source operands 210 and 220. In an alternative embodiment, the destination register 260 is one of the source registers 210 and 220. A separate destination register provides more flexibility and power for the instruction because the source registers can be reused for other operations. Furthermore, the circuit is simpler and more efficient because there is no need to provide a feedback path to load the result back to one of the source registers. The destination register 260 may be one of the registers in the register set 116 (FIG. 1), having the same data representation format as the source operands. The destination operand is a vector having N data elements.

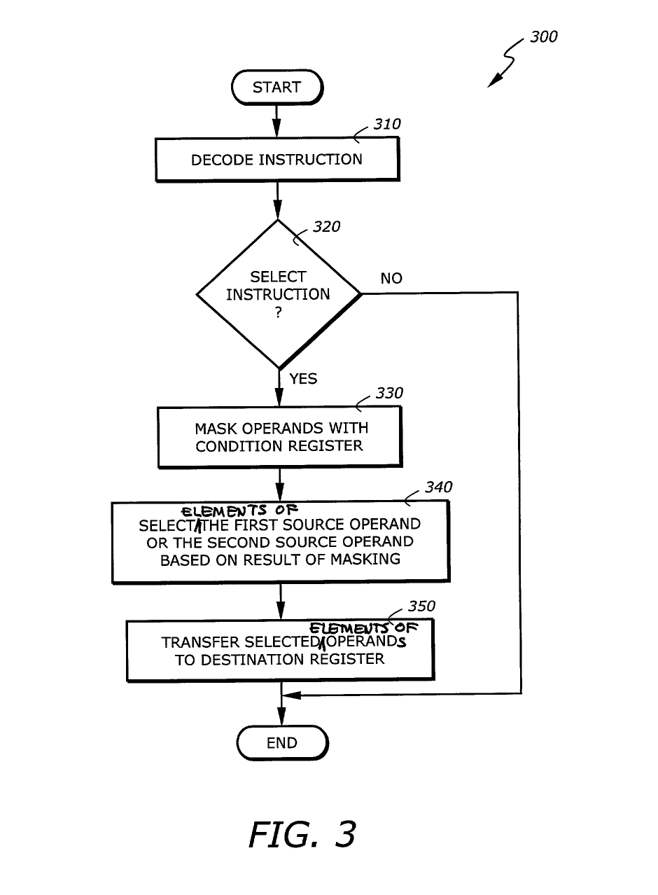

FIG. 3 is a flowchart illustrating a process of selecting operands according to one embodiment of the invention.

Upon START, the process 300 decodes the instruction (Block 310) as part of the normal decoding process. Then, the process 300 determines if the decoded instruction is a select instruction (e.g., FSELECT) (Block 320). If not, the process 300 is terminated. If the decoded instruction is a select instruction, the process 300 performs a masking operation using the condition register as a mask register (Block 330). In one embodiment, the masking operation includes N number of AND operations between N elements of the two source operands and the bit fields of the condition register and its complement.

Next, the process 300 selects the destination operand from the elements of the first and second source operands based on the result of the masking, or evaluation of the condition (Block 340). The selection may be performed as an OR operation between the results of the masking operations, or an explicit selection operation. The selected elements of the operands are then transferred to the destination register (Block 350). The process 300 is then terminated.

The invention can find applications in many engineering and computer problems such as signal processing, image processing, and graphics. In three-dimensional (3-D) graphics, hidden surface removal for 3-D objects uses floating-point computations to maintain high accuracy and dynamic range. Algorithms for hidden surface removal include the Z-buffer algorithm and compositing. The depth coordinates (the z-coordinates) of the object are used to enable the compositing or merging of separately generated scene elements. The floating-point select instruction is particular useful to compositing or merge the scene elements based on comparison results of the z-coordinates. The condition register may represent the depth comparison results. The two source operands may represent the two vectors corresponding to pixels elements from two scenes. The destination register may represent the result pixel vector of the hidden surface removal.

Another example is the frequency domain filtering of signal or image data. It is known that filtering of signals is best performed in the frequency domain. An analog signal, such as a speech waveform, can be digitized and stored in a buffer memory. The processor converts the time-domain signal into a frequency-domain spectrum. To maintain high accuracy and dynamic range, these frequency-domain calculations are usually performed using floating-point numbers. Filtering in the frequency domain involves changing the values at certain frequency components to desired values. For example, to reduce speckles in a 2-D image, the high frequency components are usually replaced by zero values (lowpass filter). A floating-point select instruction is particular useful to perform this conditional data movement. The condition register may contain the selected frequency locations. The two source operands may correspond to the frequency values of the frequency-domain images. The destination operand represent the filtered values. This filtering process using floating-point conditional select can be applied for both 1-D and 2-D signals.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A method for transferring data from at least two source operands to a destination operand based on a condition, the method comprising:
(a) generating a condition operand from the condition;
(b) masking the at least two source operands by the condition operand to generate a masking result; and
(c) selecting elements of the at least two source operands based of the masking result.

2. The method of claim 1 wherein the masking includes an AND operation between a bit field of the condition operand with a first element of one of the source operands to produce a first result.

3. The method of claim 2 wherein the masking includes an AND operation between a complement of the bit field the condition operand with a second element of one other of the source operands to produce a second result.

4. The method of claim 3 wherein the selecting includes an OR operation between the first and second results.

5. The method of claim 1 wherein the source and destination operands have a same representation format.

6. The method of claim 5 wherein the source and destination operands each have a plurality of elements.

7. An apparatus for transferring data from at least two source operands to a destination operand based on a condition, the at least two source operands being stored in respective source registers, the apparatus comprising:
(a) a condition register that stores a condition operand from the condition;
(b) a masking circuit coupled to the at least two source registers for masking the at least two source operands by the condition operand to generate a masking result; and
(c) a selector coupled to the masking circuit for selecting elements of the at least two source operands based of the masking result.

8. The apparatus of claim 7 wherein the masking circuit includes an AND gate for performing an AND operation between a bit field of the condition operand with a first element of one of the source operands to produce a first result.

9. The apparatus of claim 8 wherein the masking circuit includes an AND gate for performing and AND operation between a complement of the bit field of the condition operand with a second element of one other of the source operands to produce a second result.

10. The apparatus of claim 9 wherein the selector includes an OR gate to perform an OR operation between the first and second results.

11. The apparatus of claim 7 wherein the source and destination operands have a same representation format.

12. The apparatus of claim 11 wherein the source and destination operands each have a plurality of elements.

13. The apparatus of claim 7 further comprising:
(d) a destination register coupled to the selector for storing the destination operand, the destination operand including selected elements of the at least two source operands.

14. A system comprising:
a memory for storing an instruction sequence; and
a processor coupled to the memory for fetching the instruction sequence and executing an instruction therefrom to transfer data from at least two source operands to a destination operand based on a condition, the executing causing the processor to at least:
(a) generate a condition operand from the condition,
(b) mask the at least two source operands by the condition operand to generate a masking result, and
(c) select elements of the at least two source operands based of the masking result.

15. The system of claim 14 wherein the source and destination operands have a same representation format.

16. The system of claim 15 wherein the source and destination operands each have a plurality of elements.

17. A system comprising:
a memory for storing an instruction sequence; and
a processor coupled to the memory for fetching the instruction sequence and executing an instruction therefrom, the processor comprising a selection circuit, the selection circuit performing the instruction to transfer data from at least two source operands to a destination operand based on a condition, the at least two source operands being stored in respective source registers, the selection circuit comprising:
(a) a condition register that stores a condition operand from the condition,
(b) a masking circuit coupled to the at least two source registers for masking the at least two source operands by the condition operand to generate a masking result, and
(c) a selector coupled to the masking circuit for selecting elements of the at least two source operands based of the masking result.

18. The system of claim 17 wherein the masking circuit includes an AND gate for performing an AND operation between a bit field of the condition operand with a first element of one of the source operands to produce a first result.

19. The system of claim 8 wherein the masking circuit includes an AND gate for performing an AND operation between a complement of the bit field of the condition operand with a second element of one other of the source operands to produce a second result.

20. The system of claim 19 wherein the selector includes an OR gate to perform an OR operation between the first and second results.

21. The system of claim 17 wherein the source and destination operands have a same representation format.

22. The system of claim 21 wherein the source and destination operands each have a plurality of elements.

23. The system of claim 17 further comprising:
(d) a destination register coupled to the selector for storing the destination operand, the destination operand including selected elements of the at least two source operands.
